(19) United States
(12) Patent Application Publication
(10) Pub. No.: US 2023/0021858 A1
(43) Pub. Date: Jan. 26, 2023

(54) METHOD AND SYSTEM FOR IMPROVED SENTIMENT ANALYSIS

(71) Applicant: EMC IP Holding Company LLC, Hopkinton, MA (US)

(72) Inventors: Anne Marie McReynolds, San Jose, CA (US); Nicole Reineke, Northborough, MA (US)

(21) Appl. No.: 17/443,054

(22) Filed: Jul. 20, 2021

(51) Int. Cl. G06Q 30/00; G06F 16/23; G06N 5/04

(52) U.S. Cl. CPC G06Q 30/016; G06F 16/2379; G06N 5/04

(57) ABSTRACT

A method for generating a sentiment score for a computer application user. An interface receives user input accessing a first observable goal as part of a user application. In response to receiving user input accessing the first observable goal, the system generates a first observable goal record for the first observable goal. In response to identifying an issue with the first observable goal, system tags the first observable with an issue notice tag for the issue and tracks one or more interactions that correspond to the first observable goal and the issue based on the issue notice tag. Each interaction is assigned a sentiment value score. The system generates a first sentiment score for the first observable goal by combining the sentiment value score for each of the interactions.

### FIELD OF THE INVENTION

Embodiments of the present invention generally relate to machine sentiment analysis. More particularly, at least some embodiments of the invention relate to systems, hardware, software, computer-readable media, and methods for tracking user sentiment during a process of interaction with one or more applications and determining the appropriate time to trigger human customer service intervention.

### BACKGROUND

Sentiment analysis is an emerging field in machine learning, which seeks to train a machine learning model or network to measure human sentiment through various user interactions with a computing system. Sentiment analysis uses natural language processing, text analysis, computational linguistics, and biometrics to determine various levels of negative and/or positive sentiment of the user.

Intelligent information technology (IT) solutions have begun to leverage customer intelligence over entire networks to enable autonomous remediation. This facilitates a decreasing need for human touch during the problem identification and remediation process for customers. However, increasing customers' interactions with semi or fully automated IT infrastructure may leave customers frustrated with the current service being rendered. Furthermore, with greater IT visibility across modern and traditional application infrastructures that include multiple clouds and virtualized networks, observable outputs tied solely to performance monitoring fail to capture user reaction to operation inefficiencies.

Traditional tracking of click-throughs, page view analysis, or other conventional web analytics fail to accurately monitor a customer's sentiment level. These traditional approaches for identifying frustrated customers are resource-heavy and slow. For example, manually looking through post-call data to find unsatisfied customers often will fail to catch issues until days or weeks later. By then, it may be too late to make amends with the customer, and in some cases, an isolated issue may impact hundreds of customers. What is needed, therefore is an improved mechanism for monitoring customer satisfaction or frustration during implementation of various user applications.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates an example embodiment of tracking user sentiment across different user interactions with an application;

FIG. 2 illustrates an example embodiment of an observable goal tracking database;

FIGS. 3 illustrates an example embodiment of creating a new observable goal record and display as part of a user interface;

FIG. 4 illustrates an example embodiment of multiple contributors being related to multiple observable goals;

FIG. 5 illustrates an example embodiments of an interaction record;

FIG. 6 illustrates an example embodiment of an observability-based sentiment engine;

FIG. 7 illustrates an example embodiment of a process flow diagram for tracking user sentiment and triggering IT support;

FIG. 8 illustrates an example embodiment of a process flow diagram for recording observable goal access records in the observable goal tracking database;

FIG. 9 illustrates an example embodiment of a table that presents how the disclosed embodiments measure a user's sentiment score overtime; and

FIG. 10 illustrates an example embodiment of a computing system environment in which the disclosed embodiments are implemented.

### DETAILED DESCRIPTION OF SOME EXAMPLE EMBODIMENTS

Embodiments disclosed herein relate to methods, systems, and devices (e.g., computing systems, computing appliances and devices, hardware storage devices, wearable devices, etc.) for measuring customer satisfaction using sentiment analysis. More particularly, disclosed embodiments are directed to methods, systems, and devices for more precisely measuring and normalizing human sentiment based on observable goals. An observable goal is measured by correlating a large number of secondary source data (like logs, notifications, etc.) and includes the full stack of data from infrastructure to applications, as well as overall digital experience, business KPIs and social sentiment. Disclosed embodiments beneficially track relationships and dependencies between these elements.

Disclosed embodiments are directed to measuring a level of customer satisfaction based on sentiment analysis of various customer-computer interactions. For example, systems, methods, and devices are provided for generating a sentiment score for a computer application user. An interface receives user input accessing a first observable goal as part of a user application. In response to receiving user input accessing the first observable goal, the system generates a first observable goal record for the first observable goal. In response to identifying an issue with the first observable goal, system tags the first observable with an issue notice tag for the issue and tracks one or more interactions that correspond to the first observable goal and the issue based on the issue notice tag. Each interaction is assigned a sentiment value score. The system generates a first sentiment score for the first observable goal by combining the sentiment value score for each of the interactions.

Disclosed embodiments are also directed to a computing system having an interface configured as an observable goal access layer configured to receive user input selecting one or more observable goals, an observable goal tracking database configured to store a plurality of observable goal records and a plurality of user interaction records, and an observability-based sentiment engine configured to analyze the plurality of observable goal records and plurality of user interactions records to generate user sentiment scores and intervention triggers based on a particular user sentiment score exceeding a pre-determined sentiment score threshold. The system also includes one or more processors; and one or more hardware storage devices that store one or more computer-readable instructions that are executable by the one or more processors to configure the computing system to perform a plurality of method acts.

For example, the computing system is configured to receive a first user input selecting a first observable goal as part of a user application at the interface. In response to receiving user input select the first observable goal, the system generates a first observable goal record for the first observable goal and stores the observable goal record in the observable goal tracking database. Subsequently, the system receives one or more user inputs corresponding to one or more interactions of the user in relation to the first observable goal, and in response to identifying an issue with the first observable goal, tags the first observable goal with an issue notice tag for the issue, wherein the observable goal record stored in the observable goal tracking database is updated. The system tracks the one or more interactions that correspond to the first observable goal and the issue based on the issue notice tag and uses the observability-based sentiment engine to assign a sentiment value score for each of the one or more interactions. Finally, the system generates a first sentiment score for the first observable goal by combining the sentiment value score for each of the one or more interactions.

### Examples Of Technical Benefits, Improvements, And Practical Applications

The following section outlines some example improvements and practical applications provided by the disclosed embodiments. It will be appreciated, however, that these are just examples only and that the embodiments are not limited to only these improvements. The disclosed embodiments bring about real and substantial benefits to the technical field.

The system beneficially provides a more accurate measurement of observable goals and issues by tracking second touch points and user interaction through record keeping with tagging, issue fetching, and observable goal-issue correlation. Subsequent generations of total sentiment scores are then used to generate intervention triggers for issue remediation in system applications or even third-party applications. The system is able to provide a more accurate measurement of user sentiment because it generates initial scores and then tracks cumulative effect on those scores. By comparing scores at different levels (e.g., observable goal, issues, per user, per user type, per company, or across multiple companies), the system is able to normalize the sentiment understanding.

Thus, the generated intervention triggers are more informed based on this tracked and analyzed data. The intervention triggers are further optimized due to the feedback mechanism provided that improves the modeling of inferring when human intervention is needed based on the normalized sentiment scores. Accordingly, these and numerous other benefits will be described in more detail throughout the remaining portions of this disclosure.

As customer interactions with automated IT infrastructure increases, systems will require a new oversight or monitoring model that alerts IT personnel when manual intervention is needed or would improve a customer's interaction. A new paradigm grounded in “pragmatic observability” infers human sentiment from “observable goal” oriented behavior across multiple customer contact channels. Behavioral indicators of affect can help solution or service providers more accurately detect negative feelings, like frustration, that arise when the customer attempts to achieve a goal associated with their system but are thwarted. Disclosed embodiments are directed to accelerating the time it takes for an IT customer service provider to intervene during a customer's frustrating interaction.

Because error notifications are no longer “low-level” or specific to individual system components but are rolled up into service impact views of interrelated ecosystems, traditional metrics used to track and measure customer sentiment cannot identify blocks to customer goal attainment, thereby increasing the amount of time a customer remains frustrated with a failed goal. For example, a common practice is to observe and monitor infrastructure performance logs and metrics to determine event correlation and analysis. In the past, IT personnel were responsible for interpreting the datasets and deciding on the next best action. Manually aggregating, analysis, and acting on event data from multiple data streams across stacks, and understanding how those streams apply to each other, increases the risk of human error.

Rising error rates and longer response times result in dissatisfied end users, thereby negatively impacting customer satisfaction. Thus, disclosed embodiments are directed to a new interaction model that improves customer-system interaction monitoring as part of a goal-based paradigm associated with behavioral observability. The new interaction monitoring model also utilizes generated alerts, opened emails, and other customer interactions that are viewed outside of the centralized IT management user interface. Tracking these types of interactions offer additional insight into the user sentiment.

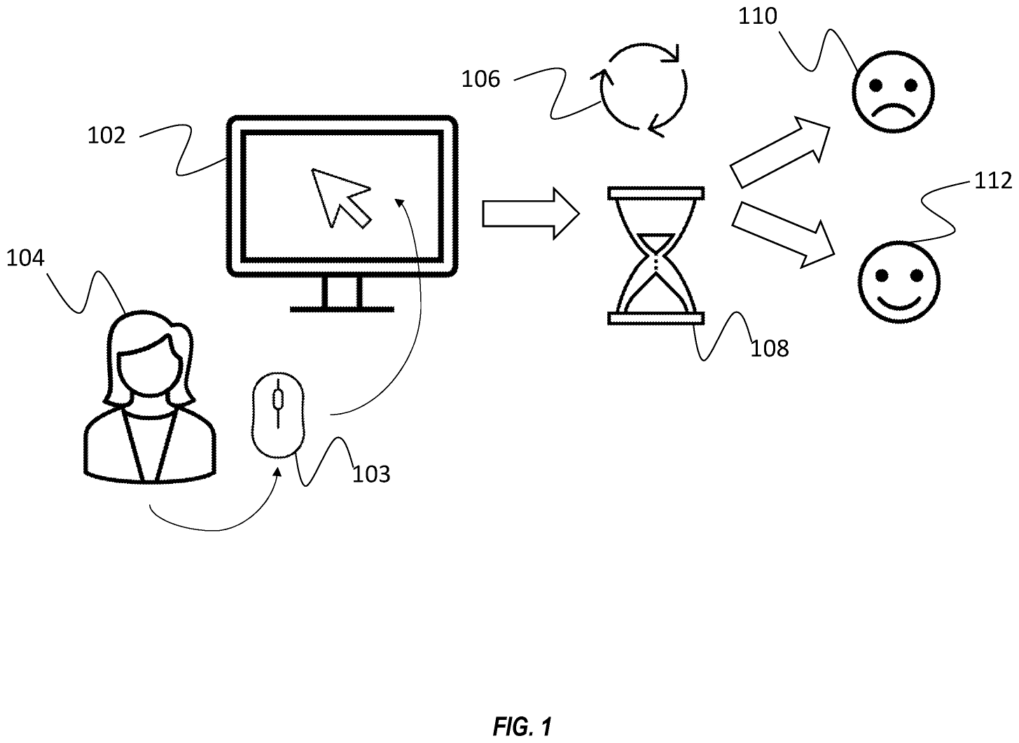

Attention will now be directed to FIG. 1, which illustrates an example embodiment of an application system employing an observable goal interaction monitoring regime. For example, FIG. 1 depicts an application on user device 102 that has been deployed by an IT department of a company. The company has set a high value on a user's ability to access the application, such that the Observable Goal being tracked is the application's adherence to a user's Service Level Agreement (SLA). Essentially, the observable goal is defined as ensuring that the application performs according to the specifications laid out in the corresponding SLA. A user 104 interacts with the application through a user input device (e.g., mouse 103) to select various observable goals being tracked by the system. As the user 104 interacts with the application, the system monitors click-throughs, as well as the time a user spends trying to resolve an issue (e.g., time duration 108), or can track if a user's click-throughs are cyclical 106 (until, for example, they abandon the interaction). Based on various metrics, the system is able to assign a positive value (e.g., positive icon 112) or a negative value (negative icon 110) to determine a sentiment score for the user at an application or observable goal level.

From the IT personnel perspective, an interface is provided, which names the application, the level of detail of the SLA. and the current state of the observable goal (e.g., “At Risk”) as the system monitors the user's interactions and actions. When a user “clicks-through” to explore a particular goal, the system tracks the next highest level of detail contributing to the SLA, such as application performance, network performance, storage performance, database performance (e.g., issue: indicator of upgrade being out of compliance), communication speed between storage and memory, memory, firmware performance, service performance, and other relevant metric data. Under a conventional click-through paradigm tracking system, assessment of the user's sentiment would only be recorded when the user clicks on a specific error notice, nor would the system be able to track if the user accessed the issue notice at another time, or through another application such as email.

Thus, disclosed embodiments provided improved sentiment monitoring, wherein the system tracks the first interaction with an issue at the click of the original observable goal. By tracing the Observable Goal as one point of origin for interacting with an issue (e.g., upgrade needed), and understanding all other interactions related to the observable goal, the system can more accurately measure issue sentiment. Tracing observable goal interactions that include an issue are actionable by trying this to observable, typified human, company, and cross-company interactions so that the system can normalize the interactions by observable goals, or the issue is abandoned.

For example, a user could waste time link clicking and searching for content that could be easily located by customer service communication. A trial-and-error approach to self-remediation of issues can lead to Observable Goal and issue abandonment, which are behavioral triggers for human-human interaction. The system generates a correlation of Observable Goals interactions and issues as they are formed in a complex IT environment. Essentially, the system is able to quantify a totality of interactions and infer customer frustration within an IT observability platform.

Other problems with conventional systems include that conventional interaction measurements do not take into consideration IT-related Observable Goals and therefore, mis-measure sentiment. For example, page views, click-through measurements, and other observation paradigms in IT user interfaces fail to generate meaningful understanding in an observable goal paradigm. This is especially prevalent in machine learning operations and artificial intelligence operations where data is collated from multiple sources to a create a high-level understanding of overall system health. By utilizing only conventional click tracking rather than associative interactions, traditional sentiment measurement only counts direct interactions with issues, pages, or links. The present invention beneficially generates correlative associations in line with IT's highest priorities (e.g., observable goals for a customer/user) since issues often impact more than one observable goal.

For example, a single issue (e.g., “failed system”) can impact multiple workloads. Thus, this will in turn impact multiple observable goals. With traditional analysis, sentiment tallying is unable to trace the user's interactions across clicking through each workload summary as the underlying error is often buried multiple layers into the graphical user interface (e.g., when only using post-click collated data population). It would fail to capture the overall level of frustration. By including issue fetching and repeatable tag correlation, disclosed embodiments provide clearer understanding of true issue impact.

Furthermore, conventional self-service during issue resolution does not have a clear point in time to transition to human-assisted service because there is a lack of clarity for when and where human intervention is required. Thus, the behavioral observability tracking system described herein improves upon existing systems by providing a way to automatically trigger IT involvement, even before a customer becomes overly frustrated or dissatisfied with their application. Additionally, traditional methods fail to recognize sentiment accurately, which leads to missed indicators of negative sentiment, thus causing delayed intervention, increased customer frustration, and delayed application update opportunities. Thus, the novel methods, systems, and devices described herein capture a higher proportion of indicators for negative sentiment and allow an IT customer service representative to intervene more quickly and timely when a customer is experiencing an issue.

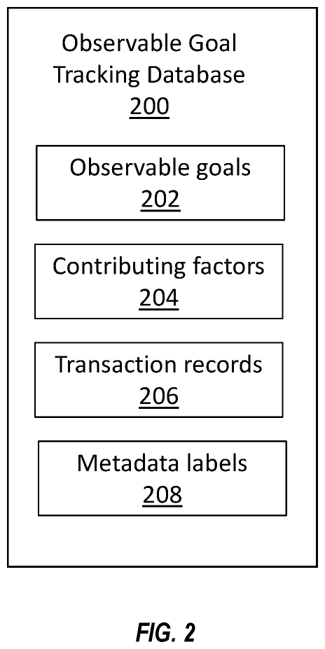

Attention will now be directed to FIG. 2, which illustrates an observable goal tracking database 200 (i.e., OGTD) which is a database that collects records for observable goals 202, contributing factors 204, transaction records 206, and other metadata labels 208. It should be appreciat3ed that the database is configured as any database or other structured or unstructured record mechanism.

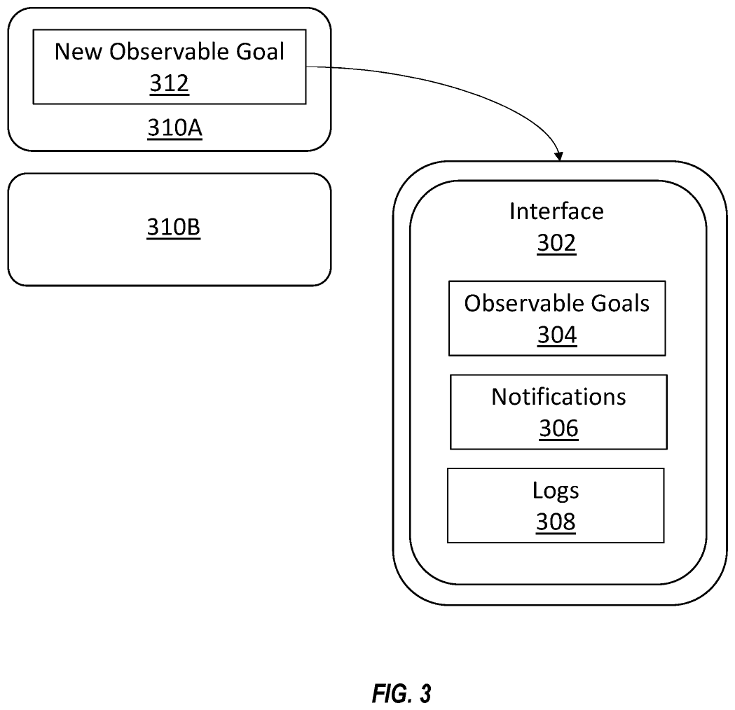

Attention will now be directed to FIG. 3, which illustrates an observable goal access layer (OGAL) which is an interface that shows various observable goals. This portion is typically implemented by default upon user application deployment by an IT administrator. As shown in FIG. 3, any number of contributors or sources (e.g., source 310A or source 310B) are able to generate a new observable goal (e.g., new observable goal 312). Thus, a new observable goal creation triggers an OGTB record. One location in which an observable could be created would be Salesforce.com, another may be Apex User interface console, or other location. The interface 302 is a collation of notifications 306 and logs 308 from all contributors to each of the observable goals 304. All known observable goals will have records.

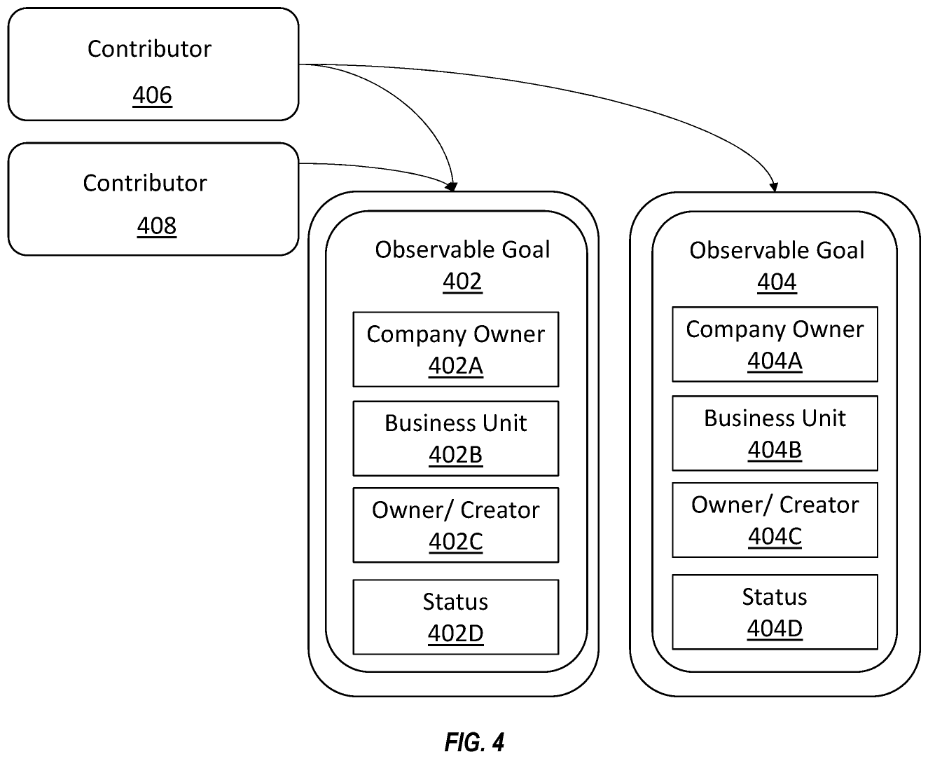

Attention will now be directed to FIG. 4, which illustrates a record for an observable goal. As shown in FIG. 4, common observable goals (e.g., observable goal 402, observable goal 404) include the company owner's name (e.g., company owner 402A, company owner 404A), business unit (e.g., business unit 402B, business unit 404B), or other level of granularity that matches the organization layout of the company or IT infrastructure. Observable goals generated by a specific person also have a record/ metadata for the owner or creator of the observable goal (e.g., owner/creator 402C, owner/creator 404C). The observable goal record also includes a status indicator of the observable goal (e.g., status 402D, status 404D).

The OGTD traces all contributors to the observable goal (e.g., contributor 406, contributor 408) through direct access to the contributing notifications, logs, and other contributors to the observable goal. This list can be obtained through the OGAL. Any notifications or issues that are non in a known “Good” state (as determined by notification indicators, log indicators, or other indicators on messages) becomes “issues” and a tag is generated that is self-describing such that the system is able to identify when one “issue” impacts two observable goals. The observable goal accessed record is tagged with the issue self-describing tag. Each interaction is tagged with metadata on the observable goal. If it is in an interaction with a direct notification or issue, the various metadata tags are associated directly with the interaction record. This enables the system to perform both observable goal-issue calculations and issue-action calculations.

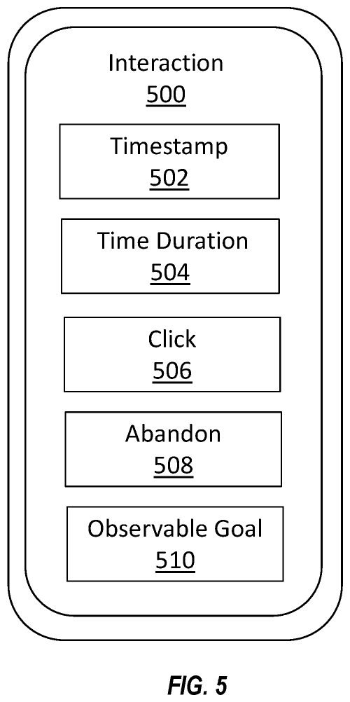

Attention will now be directed to FIG. 5, which illustrates an interaction record 500. Interaction data includes a timestamp 502, a time duration 504, a click record 506, an abandon action record 508 and the associated observable goal 510. The timestamp 502 is the single timepoint of when a user commenced the interaction. The time duration 504 is the time the user spent performing the interaction. The click record 506 is a record of the number and sequencing of click actions taken by the user. The abandon action record 508 is a recording of when a user abandons the observable goal or the interaction.

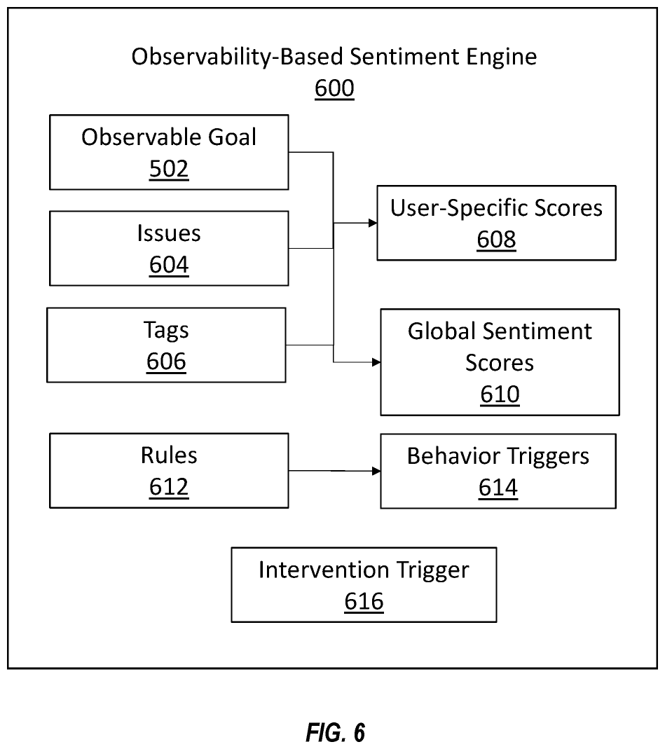

Attention will now be directed to FIG. 6, which illustrates an example embodiment of an observability-based sentiment engine (e.g., OBSE 600). For example, the observability-based sentiment engine (OBSE) is configured as a tracking mechanism that makes a record of each interaction in the OGTD. The OBSE 600 drives analysis and sends triggers for intervention. This also allows for trigger settings and feedback. Examples of tasks that are enabled include generating user-specific scores 608 and global sentiment scores 610 based on observable goals 602, issues 604, and tags 606. The OBSE 600 also triggers behaviors (e.g., behavior triggers 614) based on various rules 612. In some embodiments, the behavior triggers 614 are created based on an API call. In other instances, OBSE 600 triggers based on access to observable goals which include issues that trigger a live indicator watch state. The OBSE 600 is also configured to generate an intervention trigger 616 which is the event of notifying an IT specialist to reach out to a customer whose sentiment measurement falls below the acceptable threshold.

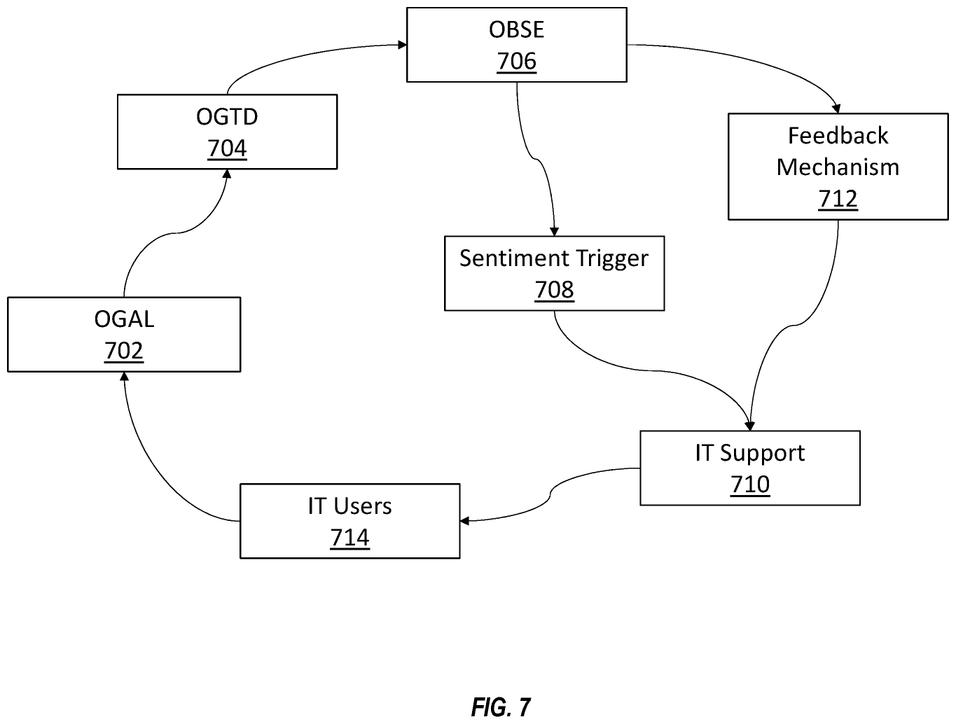

Attention will now be directed to FIG. 7, which illustrates a process flow diagram of utilizing a customer service intervention tracking system (e.g., observable goal sentiment system) as described according to embodiments disclosed herein. For example, at the observable goal access layer (OGAL 702), pre-existing notifications and logs are collated and displayed through a user interface as observable goals. A pre-existing user interface or access layer is also able to trigger access. As an IT user access a particular user interface, the system will send tracking records to the observable goal tracking database (OGTD 704) at which point the observable goal access is recorded. The observable goal record is tagged with the user and the datetime, along with other metadata.

Subsequently, the OGTD 704 accesses pre-existing collated notifications and logs applicable to the selected observable goal. Any records of interest are added as tags with datetime, issues, and other logs and/or notification details within the observable goal access record. In some interfaces, this is achieved by accessing the label that is associated with a log or notification entry. The system records all error, notification, or dissatisfied path log entries as metadata labels on a record. Additionally, interactions are recorded in the OGTD 704, wherein the interactions are tagged with at least the original observable goal and datetime.

As shown in FIG. 7, an observability-based sentiment engine (OBSE 706) is triggered when a new record is added. A new record is added when an IT user (e.g., IT users 714 interact with an application). OBSE 706 generates scores of sentiments based on observable goals, general issues, specific observable goal interactions, and specific issue interactions. The system compares current sentiment scores against similar company or user scores at the observable goal level or the general issue level. For example, a threshold score is established based on normalized scores across a particular company, a particular issue, or a particular observable goal.

In some instances, the normalized value used for the threshold sentiment score is further tuned based on a particular user. For example, if a user is typically less frustrated in actuality than the sentiment score would indicate, then the threshold score is raised so that intervention does not occur pre-maturely. Conversely, if a user is much more frustrated than could be inferred from the sentiment score, the threshold score is lowered so that human IT intervention occurs more quickly to avoid a customer becoming too dissatisfied (e.g., beyond being able to repair a customer relationship).

The system compares the calculated sentiment score against the threshold value. If the sentiment score is outside of the normalized expected sentiment score (i.e., the threshold value), an intervention trigger (e.g., sentiment trigger 708) is sent to a pre-determined support system (either determined by the company, the IT department, or the user). Once the intervention trigger is generated, the customer support system of choice (e.g., IT support 710) is alerted to the need of human intervention for the issue remediation, at which point a customer service IT specialist is able to reach out directly to the user experiencing an issue (i.e., failure to achieve an observable goal). Finally, the IT support provides a rating back to the OBSE (e.g., feedback mechanism 712) which indicates if the sentiment score was accurate, if the sentiment score indicated frustration when the customer wasn't actually dissatisfied with the application, or if the sentiment score underestimated the negative sentiment. Based on this feedback, the normalized sentiment value for the threshold score is tailored to the feedback data received.

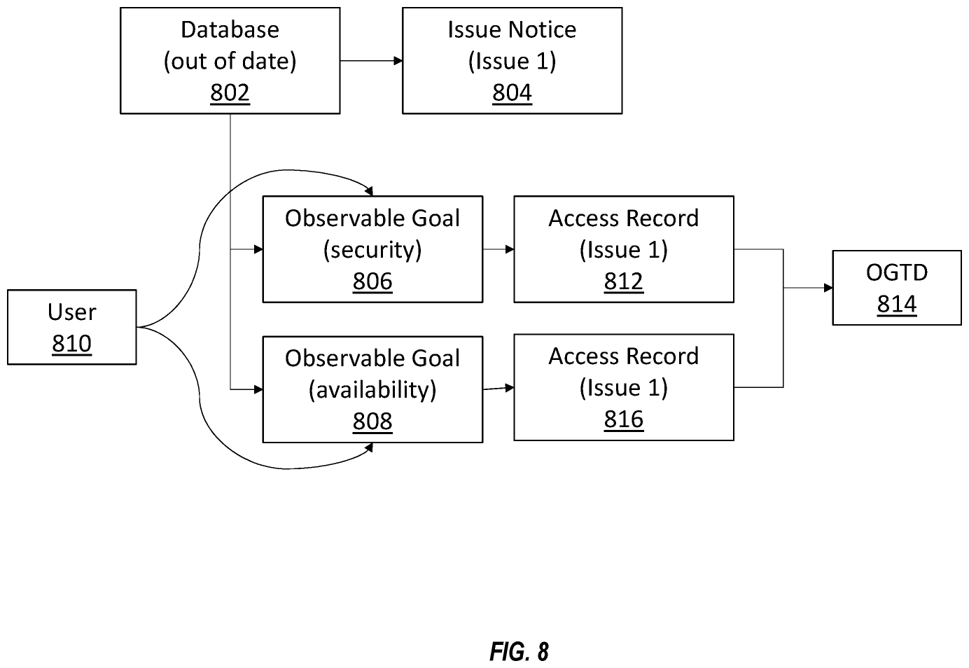

Attention will now be directed to FIG. 8, which depicts a process flow diagram for generating a sentiment score from the records and tags now stored in the OGTD. For example, FIG. 8 shows two observable goals (e.g., observable goal 806 and observable goal 808). Observable goal 806 is based on a security related observable goal, and observable goal 808 is based on an availability related observable goal. It should be appreciated that there are many types of observable goals. As shown in FIG. 8, both observable goals rely on the same database (e.g., database 802) which is out of date. Because the database 802 has failed to receive an update, the database is causing performance and security issues, thus resulting in an issue notice (e.g., issue notice 804 corresponding to Issue 1).

As the user 810 accesses one observable goal, there is an access record (e.g., access record 812, access record 816) added to the OGTD 814. Each access record is tagged with the same issue (e.g., Issue 1) which is a unique identifier that indicates the specific database upgrade error. Interactions in that session are similarly tagged with the issue. As the user moves on to access another observable goal, another access record is tagged with the same issue, since the contributing factor is the same (e.g., the database is out of date). This correlations in the tags enables the OBSE to find both the observable goals' access paths when tallying the score for the same issue.

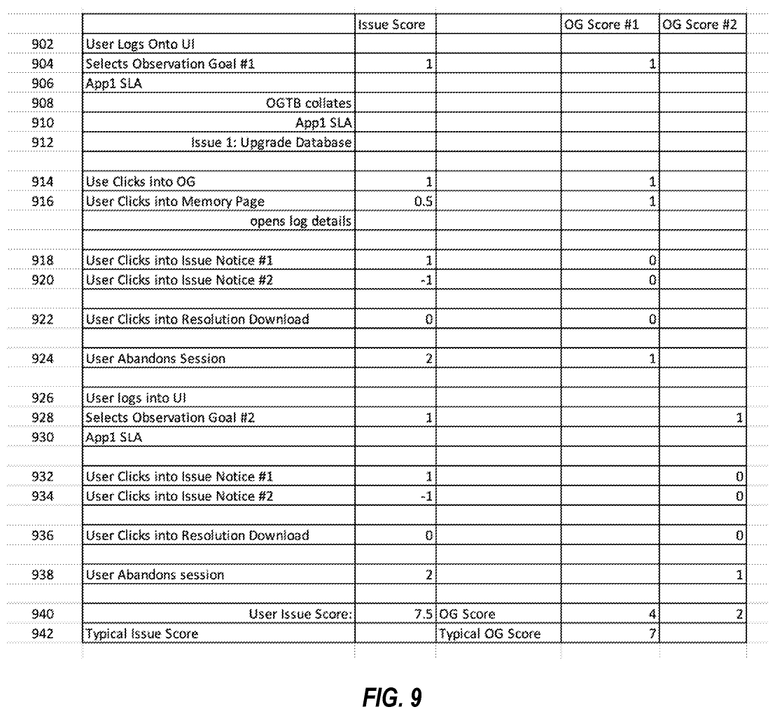

Attention will now be directed to FIG. 9, which shows an example embodiment for tracking contributions to a user's sentiment score based on interactions tagged with an issue (e.g., issue 1 of FIG. 8) in two different observable goals. In this example, the higher the actual score, the higher the negative sentiment (i.e., the more dissatisfied or frustrated a customer is inferred to be). As shown in FIGS. 8 and 9, the system is able to trace an issue to one or more observable goals. When a user interacts with an application in a particular way, the system attributes a positive value (thereby increasing the sentiment score), a negative value (thereby decreasing the overall score), or a zero value when the system determines that is the interaction is a neutral action.

By generating scores that are aligned to the same issue, the system is able to trace sentiment across multiple observable goals. Once the score of the negative sentiment surpasses a typical or normalized value (i.e., threshold score) for the user, for the issue type, or for the observable goal type, a notification triggered for the support team. Likewise, it is also important that the system is configured to create a cumulative score within various observable goals to trace on-going sentiment where the user may be experiencing application malfunctioning at multiple locations. This is common when a user experiences lots of small issues in pursuit of a larger, more complex observable goal. This often leads to undetected frustration and negative sentiment because each of the issues encountered individually fall below a pre-determined score threshold.

For example, to track the sentiment score for observable goal #1, a user logs onto a UI (act 902) which triggers the start of the tracking process. When the user selects the observable goal #1, the system records a +1 (act 904) and accesses the SLA (act 906) for the application. Subsequently, the OGTB collates the logs and the notifications (act 908), interacts with the application, and determines there is an issue with the database supporting the application. The system records a +1 when the user clicks into the observable goal (act 914). The system also adds a +1 when the user clicks into a memory page (to open log details) (act 916). The system generates a first issue notice (act 918) and a second issue notice (Act 920) which do not impact the sentiment score for observable goal #1. The sentiment score is also not impacted by the user clicking into the resolution download (act 922). However, the sentiment increases when the user abandons the session (act 924). The total sentiment score for the observable goal #1 is 4, but the system would not be triggered to provide human intervention during the issue occurrence because the typical observability goal score is 7.

The system continues to track various user interactions to determine a sentiment score for observable goal #2. For example, the user logs into the UI again (act 926), wherein the user selects the observable goal #2 (act 928) and a particular application (act 930). The system adds a +1 to the sentiment score during these interactions. The issue with the database supporting the application is still occurring, therefore the system generates a first issue notice (act 932) and generates a second issue notice (act 934). However, the system determines that these actions, including the user clicking into the resolution download (act 936) are neutral events that do not impact the sentiment score. However, when the user abandons the session, the sentiment score is increased by 1. The total sentiment score for observable goal #2 is 2, which also does not trigger the system to provide human intervention for customer service, because the typical observability goal score is 7.

The system also tracks a sentiment score for the issue and is able to correlate multiple interactions for different observable goals that are related to the same issue. The total sentiment score is 7.5 for the issue score, which does trigger the system to provide human IT intervention for the customer, because the typical issue score is 6. Thus, the system infers that the customer is experiencing a higher-than-average level of frustration. As shown in FIG. 9, the disclosed embodiments beneficially track multiple levels of sentiment scores to ensure that the system can more accurately infer the satisfaction level of the application user to provide timely customer service help, if determined to be needed.

### Use Cases

During user activity tracking, disclosed embodiments follow a “yellow brick road approach” to Observable Goal attainment by leveraging user activity across an IT environment. With increased visibility into every micro-moment in the customer journey, the system utilizes sentiment measures (web and click analytics, open and click-through rates for push notifications and emails, and goal conversions for in-app messages) to track engagement and detect roadblocks to Observable Goal attainment that lead to negative emotions.

Disclosed embodiments are also directed to tracing the digital footprint related to observable goal tracking. For example, in a tap click interaction model, users leave a traceable digital footprint that provides observable behavioral indicators of sentiment. Like software Observability collects external output to infer the internal state of a system, the trail of data outside the centralized IT management user interface also provides insights into the user's emotional state. Behavioral Observability allows for the systematic identification, extraction, and quantification of sentiment for the study of affective state.

The system also is able to record observable goal conversion, which is defined when a user completes an activity that contributes to an observable goal. For example, “subscription” is a goal for as-a-service business model (e.g., Dell Technologies Cloud Console). The conversion rate is the percentage of consumer sessions that result in buying—which is calculated by dividing the number of goal conversions by the number of sessions.

Poor conversion rates strongly suggest that the prescribed click path to Observable Goal fulfillment is an “unhappy” one. Instead of looking at happiness as a goal—something that the system achieves—the system treats it as a state of mind. When people are entirely in control of their situation, successful, and safe, they feel happiness. Happiness and unhappiness are mindsets that shift with experience. However, customer satisfaction (CSAT) isn't 100% correlated with objective usability metrics. Success rate alone fails to provide actionable insight into the culminating act of goal abandonment.

In contrast to traditional web analytics attribution models that credit goal conversion to the first/last interaction with an issue (e.g., in-app error message), the Behavioral Observability paradigm traces user activity with an issue (e.g., upgrade compliance) along their conversion path across multiple communication channels using associated issue and observability goals metadata labels to identify and score contributing experiences to a negative “click attitude.” For example, research shows that findability and discoverability issues demotivate users. A user could waste time link clicking and searching for content that should be easily located via customer communication. A trial-and-error approach to self-remediation may lead to Observable Goal and issue abandonment—a behavioral trigger for human-human interaction.

The disclosed embodiments are also beneficially applicable to higher-level use cases, including an ISG application update. The system analyzes the design impact of ISG Release Notes on customer adoption of new code. A Support goal is to enable most customers (with active Service Agreements) to adopt code versions within 12 months of a release for all ISG legacy EMC Storage, Data Protection, and VxRail. Some customers are running code that is more than three or four versions behind the latest and greatest. By changing Standard Support duration from 36 to 12 months, the system ensures code versions within Standard Support receive code defect fixes to remedy known issues. Customers running code within Standard Support reduce the chances of data loss or data unavailability and subsequent disruptions to their IT environments.

Thus, disclosed embodiments generate clear connections between the actions of a customer, Observable Goals for the customer (maintaining an SLA across one or more workloads or environments, where each may be considered its own goal), the issues which may impact their ability to meet their SLAs, namely out of date software, and the touchpoints which notify the customer of the issues.

This invention helps to trigger IT intervention for software updates at a more meaningful place as the system can track the perceived impact of out-of-date software notifications across multiple Observable Goals and register impact and sentiment reflective of goal interaction. The system can determine an outreach to a customer is appropriate at a place sooner than waiting for a critical failure.

### Example Computer/Computer Systems

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machines may reside and operate in a cloud environment.

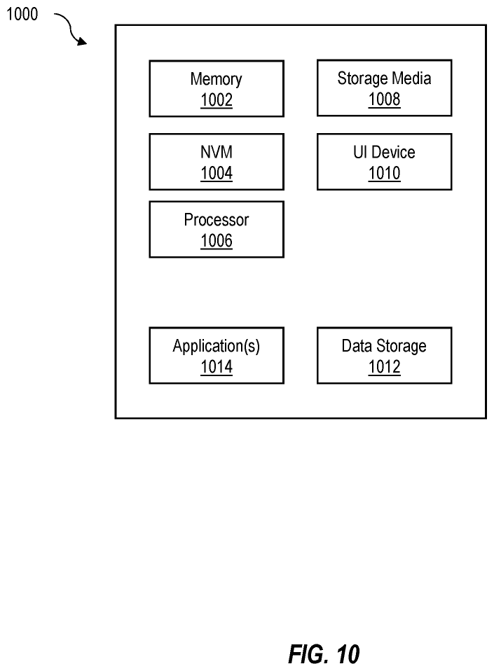

With reference briefly now to FIG. 10, any one or more of the entities disclosed, or implied, by FIGS. 1-9 and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 7.

In the example of FIG. 10, the physical computing device 1000 includes a memory 1002 which may include one, some, or all, of random-access memory (RAM), non-volatile memory (NVM) (e.g., NVM 1004) such as NVRAM for example, read-only memory (ROM), and persistent memory, one or more hardware processors 706, non-transitory storage media 1008, UI device 1010, and data storage 1012. One or more of the components included in memory 1002 of the physical computing device 1000 may take the form of solid-state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### Example Embodiments

In view of the foregoing, the present invention may be embodied in multiple different configurations, as outlined above, and as exemplified by the following aspects.

1. A method for generating a sentiment score for a computer application user, the method comprising: receiving user input accessing a first observable goal as part of a user application; in response to receiving user input accessing the first observable goal, generating a first observable goal record for the first observable goal; in response to identifying an issue with the first observable goal, tagging the first observable with an issue notice tag for the issue; tracking one or more interactions that correspond to the first observable goal and the issue based on the issue notice tag; assigning a sentiment value score for each of the one or more interactions; and generating a first sentiment score for the first observable goal by combining the sentiment value score for each of the one or more interactions.

2. The method according to preceding Aspect 1, further comprising: identifying a pre-determined sentiment score threshold; comparing the first sentiment score against the pre-determined sentiment score threshold; and in response to determining that the first sentiment score exceeds the pre-determined sentiment score threshold, generating an intervention trigger notification, wherein an IT customer service specialist is notified to contact the computer application user to mitigate the issue identified by the system.

3. The method according to preceding Aspects 1-2, wherein the pre-determined sentiment score threshold is calculated based on a normalization of a history of sentiment scores.

4. The method according to preceding Aspects 1-3, further comprising: tuning the pre-determined sentiment score threshold at a user level based on a history of user sentiment score feedback.

5. The method according to preceding Aspects 1-4, further comprising: receiving user input accessing a second observable goal; in response to receiving user input access the second observable goal, generating a second observable goal record for the second observable goal; in response to identifying that the issue with the first observable goal impacts the second observable goal, tagging the second observable goal with the issue notice tag; tracking one or more further interactions that correspond to the second observable goal and the issue based on the issue notice tag; assigning a further sentiment value score for each of the one or more further interactions; and generating a second sentiment score for the second observable goal by combining the further sentiment value score for each of the one or more further interactions.

6. The method according to preceding Aspect 5, further comprising: generating a third sentiment score for the issue by combining the sentiment value score for each of the one or more interactions and the further sentiment value score for each of the one or more further interactions.

7. The method according to preceding Aspect 6, further comprising: comparing the first sentiment score, the second sentiment score, and the third sentiment score against the pre-determined sentiment score threshold; in response to determining that the first sentiment score, the second sentiment score, or the third sentiment score exceeds the pre-determined sentiment score threshold, generating an intervention trigger notification, wherein an IT customer service specialist is notified to contact the computer application user to mitigate the issue identified by the system.

8. The according to preceding Aspects 1-7, wherein the first observable goal record further includes metadata for a name of the company owner, a business unit, a creator, and a status of the first observable goal.

9. The method according to preceding Aspects 1-8, wherein an observable goal is impacted by multiple contributors.

10. The method according to preceding Aspects 1-9, wherein the one or more interactions are associated with one or more interaction records, each interaction record including metadata for a timestamp, a time duration, user clicking, user abandonment, and a related observable goal.

11. The method according to preceding Aspects 1-2, further comprising: storing the first observable goal record in an observable goal tracking database.

12. The method according to preceding Aspects 1-10, wherein the observable goal tracking database comprises observable goals, contributing factors, transaction records, and metadata labels.

13. A computing system comprising: an interface configured as an observable goal access layer configured to receive user input selecting one or more observable goals; an observable goal tracking database configured to store a plurality of observable goal records and a plurality of user interaction records; an observability-based sentiment engine configured to analyze the plurality of observable goal records and plurality of user interactions records to generate user sentiment scores and intervention triggers based on a particular user sentiment score exceeding a pre-determined sentiment score threshold; one or more processors; and one or more hardware storage devices that store one or more computer-readable instructions that are executable by the one or more processors to configure the computing system to at least:

receive a first user input selecting a first observable goal as part of a user application at the interface; in response to receiving user input select the first observable goal, generating a first observable goal record for the first observable goal; storing the observable goal record in the observable goal tracking database; receive one or more user inputs corresponding to one or more interactions of the user in relation to the first observable goal; in response to identifying an issue with the first observable goal, tagging the first observable goal with an issue notice tag for the issue, wherein the observable goal record stored in the observable goal tracking database is updated; tracking the one or more interactions that correspond to the first observable goal and the issue based on the issue notice tag; using the observability-based sentiment engine to assign a sentiment value score for each of the one or more interactions; and generating a first sentiment score for the first observable goal by combining the sentiment value score for each of the one or more interactions.

14. The computing system according to preceding Aspect 13, the computer-readable instructions being further executable by the one or more processors to further cause the computing system to: identify a pre-determined sentiment score threshold; compare the first sentiment score against the pre-determined sentiment score threshold; and in response to determining that the first sentiment score exceeds the pre-determined sentiment score threshold, generate an intervention trigger notification, wherein an IT customer service specialist is notified to contact the computer application user to mitigate the issue identified by the system.

15. The computing system according to preceding Aspect 14, wherein the pre-determined sentiment score threshold is calculated based on a normalization of a history of sentiment scores.

16. The computing system according to preceding Aspect 15, further comprising: tuning the pre-determined sentiment score threshold at a user level based on a history of user sentiment score feedback.

17. The computing system according to preceding Aspects 13-15, the computer-readable instructions being further executable by the one or more processors to further cause the computing system to: receive a first feedback from the IT customer service specialist evaluating the accuracy of the sentiment score based on a direct interaction with the user; and use the observability-based sentiment engine to update the sentiment score threshold based on the first feedback.

18. The computing system according to preceding Aspects 13-17, the computer-readable instructions being further executable by the one or more processors to further cause the computing system to: track a set of user interactions across multiple observable goals that are negatively impacted by a common issue; use the observability-based sentiment engine to assign a plurality of sentiment value scores, each sentiment value score corresponding to at least one user interaction of the set of user interactions; and generate a global sentiment score for the common issue by combining the plurality of sentiment value scores.

19. One or more hardware storage devices that store instructions that are executable by one or more processors of a computer system to cause the computer system to: receive user input accessing a first observable goal as part of a user application; in response to receiving user input accessing the first observable goal, generate a first observable goal record for the first observable goal; in response to identifying an issue with the first observable goal, tag the first observable with an issue notice tag for the issue; track one or more interactions that correspond to the first observable goal and the issue based on the issue notice tag; assign a sentiment value score for each of the one or more interactions; and generate a first sentiment score for the first observable goal by combining the sentiment value score for each of the one or more interactions.

20. The one or more hardware storage devices according to preceding Aspect 19, wherein the instructions are further executable by the one or more processors to further cause the computing system to: identify a pre-determined sentiment score threshold; compare the first sentiment score against the pre-determined sentiment score threshold; and in response to determining that the first sentiment score exceeds the pre-determined sentiment score threshold, generate an intervention trigger notification, wherein an IT customer service specialist is notified to contact the computer application user to mitigate the issue identified by the system.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating a sentiment score for a computer application user, the method comprising:
receiving user input accessing a first observable goal as part of a user application;
in response to receiving user input accessing the first observable goal, generating a first observable goal record for the first observable goal;
in response to identifying an issue with the first observable goal, tagging the first observable with an issue notice tag for the issue;
tracking one or more interactions that correspond to the first observable goal and the issue based on the issue notice tag;
assigning a sentiment value score for each of the one or more interactions; and
generating a first sentiment score for the first observable goal by combining the sentiment value score for each of the one or more interactions.

2. The method of claim 1, further comprising:
identifying a pre-determined sentiment score threshold;
comparing the first sentiment score against the pre-determined sentiment score threshold; and
in response to determining that the first sentiment score exceeds the pre-determined sentiment score threshold, generating an intervention trigger notification, wherein an IT customer service specialist is notified to contact the computer application user to mitigate the issue that is identified.

3. The method of claim 2, wherein the pre-determined sentiment score threshold is calculated based on a normalization of a history of sentiment scores.

4. The method of claim 3, further comprising:
tuning the pre-determined sentiment score threshold at a user level based on a history of user sentiment score feedback.

5. The method of claim 1, further comprising:
receiving user input accessing a second observable goal;
in response to receiving user input access the second observable goal, generating a second observable goal record for the second observable goal;
in response to identifying that the issue with the first observable goal impacts the second observable goal, tagging the second observable goal with the issue notice tag;
tracking one or more further interactions that correspond to the second observable goal and the issue based on the issue notice tag;
assigning a further sentiment value score for each of the one or more further interactions; and
generating a second sentiment score for the second observable goal by combining the further sentiment value score for each of the one or more further interactions.

6. The method of claim 5, further comprising:
generating a third sentiment score for the issue by combining the sentiment value score for each of the one or more interactions and the further sentiment value score for each of the one or more further interactions.

7. The method of claim 6, further comprising:
comparing the first sentiment score, the second sentiment score, and the third sentiment score against a pre-determined sentiment score threshold;
in response to determining that the first sentiment score, the second sentiment score, or the third sentiment score exceeds the pre-determined sentiment score threshold, generating an intervention trigger notification, wherein an IT customer service specialist is notified to contact the computer application user to mitigate the issue identified by the system.

8. The method of claim 1, wherein the first observable goal record further includes metadata for a name of a company owner, a business unit, a creator, and a status of the first observable goal.

9. The method of claim 1, wherein an observable goal is impacted by multiple contributors.

10. The method of claim 1, wherein the one or more interactions are associated with one or more interaction records, each interaction record including metadata for a timestamp, a time duration, user clicking, user abandonment, and a related observable goal.

11. The method of claim 1, further comprising:
storing the first observable goal record in an observable goal tracking database.

12. The method of claim 10, wherein an observable goal tracking database is configured to store one or more observable goal records, wherein the observable goal tracking database further comprises contributing factors, transaction records, and metadata labels.

13. A computing system comprising:
an interface configured as an observable goal access layer configured to receive user input selecting one or more observable goals;
an observable goal tracking database configured to store a plurality of observable goal records and a plurality of user interaction records;
an observability-based sentiment engine configured to analyze the plurality of observable goal records and plurality of user interactions records to generate user sentiment scores and intervention triggers based on a particular user sentiment score exceeding a pre-determined sentiment score threshold;
one or more processors; and
one or more hardware storage devices that store one or more computer-readable instructions that are executable by the one or more processors to configure the computing system to at least:
receive a first user input selecting a first observable goal as part of a user application at the interface;
in response to receiving user input select the first observable goal, generating a first observable goal record for the first observable goal;
storing the observable goal record in the observable goal tracking database;
receive one or more user inputs corresponding to one or more interactions of the user in relation to the first observable goal;
in response to identifying an issue with the first observable goal, tagging the first observable goal with an issue notice tag for the issue, wherein the observable goal record stored in the observable goal tracking database is updated;
tracking the one or more interactions that correspond to the first observable goal and the issue based on the issue notice tag;
using the observability-based sentiment engine to assign a sentiment value score for each of the one or more interactions; and
generating a first sentiment score for the first observable goal by combining the sentiment value score for each of the one or more interactions.

14. The computing system of claim 13, the computer-readable instructions being further executable by the one or more processors to further cause the computing system to:
identify a pre-determined sentiment score threshold;
compare the first sentiment score against the pre-determined sentiment score threshold; and
in response to determining that the first sentiment score exceeds the pre-determined sentiment score threshold, generate an intervention trigger notification, wherein an IT customer service specialist is notified to contact the computer application user to mitigate the issue identified by the system.

15. The computing system of claim 14, wherein the pre-determined sentiment score threshold is calculated based on a normalization of a history of sentiment scores.

16. The computing system of claim 14, further comprising:
tuning the pre-determined sentiment score threshold at a user level based on a history of user sentiment score feedback.

17. The computing system of claim 14, the computer-readable instructions being further executable by the one or more processors to further cause the computing system to:
receive a first feedback from the IT customer service specialist evaluating an accuracy of the sentiment score based on a direct interaction with the user; and
use the observability-based sentiment engine to update the sentiment score threshold based on the first feedback.

18. The computing system of claim 13, the computer-readable instructions being further executable by the one or more processors to further cause the computing system to:
track a set of user interactions across multiple observable goals that are negatively impacted by a common issue;
use the observability-based sentiment engine to assign a plurality of sentiment value scores, each sentiment value score corresponding to at least one user interaction of the set of user interactions; and
generating a global sentiment score for the common issue by combining the plurality of sentiment value scores.

19. One or more hardware storage devices that store instructions that are executable by one or more processors of a computer system to cause the computer system to:
receive user input accessing a first observable goal as part of a user application;
in response to receiving user input accessing the first observable goal, generate a first observable goal record for the first observable goal;
in response to identifying an issue with the first observable goal, tag the first observable with an issue notice tag for the issue;
track one or more interactions that correspond to the first observable goal and the issue based on the issue notice tag;
assign a sentiment value score for each of the one or more interactions; and
generate a first sentiment score for the first observable goal by combining the sentiment value score for each of the one or more interactions.

20. The one or more hardware storage devices of claim 19, wherein the instructions are further executable by the one or more processors to further cause the computing system to:
identify a pre-determined sentiment score threshold;
compare the first sentiment score against the pre-determined sentiment score threshold; and
in response to determining that the first sentiment score exceeds the pre-determined sentiment score threshold, generate an intervention trigger notification, wherein an IT customer service specialist is notified to contact the computer application user to mitigate the issue identified by the system.
